(19) United States
(12) Patent Application Publication
(10) Pub. No.: US 2024/0125966 A1
(43) Pub. Date: Apr. 18, 2024

(54) TRANSIENT ELECTROMAGNETIC DEVICE WITH VARIABLE COIL SHAPES AND TURNS AND USE METHOD OF SAME

(71) Applicant: Yangtze River Survey Technology Research Institute, Ministry of Water Resources, Wuhan (CN)

(72) Inventors: Yuesheng LUAN, Wuhan (CN); Shizhong CHEN, Wuhan (CN); Xiaobo WANG, Wuhan (CN); Jikai WANG, Wuhan (CN); Geming ZENG, Wuhan (CN); Gang SHI, Wuhan (CN); Zhijian ZHANG, Wuhan (CN); Liang LI, Wuhan (CN); Jun ZHANG, Wuhan (CN); Tianzhu XU, Wuhan (CN); Liang ZHANG, Wuhan (CN); Xiao PAN, Wuhan (CN); Li XIAO, Wuhan (CN); Zhou'e WANG, Wuhan (CN); Yunfa ZHU, Wuhan (CN); Liangzi YIDU, Wuhan (CN); Yanian ZHANG, Wuhan (CN); Jie LUO, Wuhan (CN)

(21) Appl. No.: 18/147,423

(22) Filed: Dec. 28, 2022

(30) Foreign Application Priority Data
Oct. 13, 2022 (CN) 202211254430.7

(51) Int. Cl. G01V 3/06; G01V 3/12; G01V 3/40

(52) U.S. Cl. CPC G01V 3/06; G01V 3/12; G01V 3/40; G01V 3/10

(57) ABSTRACT

A transient electromagnetic device with variable shape and turns includes squares, a transmitting coil carrying frame, a transmitting coil, a turns-variable device, a current generator and a working power supply. The transmitting coil carrying frame is arranged inside the transmitting coil; the transmitting coil carrying frame is configured as a carrier of the transmitting coil, and configured for adjusting a side length of the transmitting coil and a shape of the transmitting coil; the square is configured for clamping and connecting the transmitting coil and the transmitting coil carrying frame to fix the transmitting coil to the transmitting coil carrying frame. The current generator is configured for generating transient current; the turns-variable device is configured for changing the turns of the transmitting coil; and the transmitting coil is configured for transmitting the transient current to a target area to be measured.

### CROSS-REFERENCE TO RELATED APPLICATION

This patent application claims the benefit and priority of Chinese Patent Application No. 202211254430.7 filed with the China National Intellectual Property Administration on Oct. 13, 2022, the disclosure of which is incorporated by reference herein in its entirety as part of the present application.

### TECHNICAL FIELD

The present disclosure relates to the technical field of geophysical exploration electromagnetic prospecting, in particular to a transient electromagnetic device with variable coil shapes and turns and a use method of the same.

### BACKGROUND

In the transient electromagnetic measurement process, transient magnetic field is transmitted to the underground by using an ungrounded coil. Generally, a current square wave is supplied on the transmitting coil, which can generate stable distribution of the magnetic field underground. When the current square wave is disconnected, eddy current is generated through earth medium. The eddy current depends on the conductive degree of the earth medium. The eddy current cannot disappear instantly, and the eddy current disappears in a transition process, the magnetic field generated in the transition process is propagated to the earth surface. The receiving coil on the earth surface converts changes of the magnetic field into changes of induced voltage.

In recent years, the transient electromagnetic method has been rapidly developed in the world, and is involved in almost all fields of geophysical exploration. As an earth electricity structure for exploring karst caves, cavities, faults, underground water and places from shallow strata to middle-deep strata, the method can achieve more ideal geological effect compared with other geophysical exploration methods. It needs to be mentioned that the method has good effects in water exploration, municipal engineering, soil salinization, pollution survey and shallow strata petroleum construction charting.

In the present stage, the transmitting coil carrying frame still needs to be carried by an operator in the using process of transient electromagnetic equipment. The common transmitting coil carrying frame is formed by simply splicing wooden sticks, resulting in a series of problems, such as inconvenience to carry the equipment, limited length of the wooden sticks, unstable arrangement angle, and a corner of a right angle being not approximate a right angle; such problems greatly influence the data collection, and even the condition of abnormal data collection may occur. In order to solve the problems, many solutions are proposed by technicians in these years, but most of the solutions focus on convenience, and the study on stability of the transmitting coil carrying frame is not sufficient. Furthermore, the burns need to be set according to the geological conditions of exploration and the expected result map in the exploration process of the transient electromagnetic device. To a certain extent, the larger the selected value of the turns is, the higher the exploration depth of the transient electromagnetic device is. However, the problems of increased shallow blind area and reduced exploration precision may be caused by increasing the turns, and therefore, the selection of turns is very important for the exploration depth and the exploration precision. In most transient electromagnetic devices, the turns are replaced by resetting the transmitting coil and the connecting wires, which increases the workload of the operator, and has low work efficiency.

### SUMMARY

In order to overcome the disadvantages in the prior art, an object of the present disclosure is to provide a transient electromagnetic device with variable coil shapes and turns and a use method of the same. According to the device, the stability and convenience of the transmitting coil carrying frame and the exploration precision are promoted, and the labor cost is reduced.

In order to achieve the object, the present disclosure provides the following technical solution.

A transient electromagnetic device with variable coil shapes and turns includes:
squares, a transmitting coil carrying frame, a transmitting coil, a turns-variable device, a current generator and a power supply, where the a transmitting coil, the turns-variable device, the current generator and the power supply are sequentially connected;
the transmitting coil carrying frame is arranged inside the transmitting coil;
the transmitting coil carrying frame is configured as a carrier for the transmitting coil, and is configured for adjusting a side length of the transmitting coil and a shape of the transmitting coil;
the squares are configured for clamping and connecting the transmitting coil and the transmitting coil carrying frame to fix the transmitting coil to the transmitting coil carrying frame;
the current generator is configured for generating transient current;
the turns-variable device is configured for changing turns of the transmitting coil; and
the transmitting coil is configured for transmitting the transient current to a target area for measurement.

According to specific embodiments provided by the present disclosure, the present disclosure has the following technical effects.

According to the transient electromagnetic device and the use method provided by the present disclosure, the transmitting coil carrying frame can be applicable for larger transmitting coils through the external wooden supports. The bottom of the main wooden support and the top of the external wooden support can be connected to the square. The square can be clamped on the transmitting coil to prevent the wooden support from possibly falling off from the transmitting coil. The transient electromagnetic device is stable in structure and convenient to carry, the cost is reduced and the work efficiency is improved; and furthermore, the turns can be changed through the turns-variable device, so that the exploration precision is improved.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those skilled in the art may still derive other accompanying drawings from these drawings without creative efforts.

FIG. 1 is a structural schematic diagram of a transient electromagnetic device according to an embodiment of the present disclosure;

FIG. 2 is a schematic diagram showing a transmitting coil carrying frame unfolded, provided by an embodiment of the present disclosure;

FIG. 3 is a schematic diagram showing the transmitting coil carrying frame folded, provided an embodiment of the present disclosure;

FIG. 4 is a detailed schematic diagram of a square provided by an embodiment of the present disclosure;

FIG. 5 is a detailed schematic diagram of a main wooden support provided by an embodiment of the present disclosure;

FIG. 6 is a detailed schematic diagram of an external wooden support provided by an embodiment of the present disclosure;

FIG. 7 is a schematic diagram showing connection between the wooden support and the square provided by the embodiment of the present disclosure;

FIG. 8 is a schematic diagram showing connection between the main wooden support and the external wooden support provided by the embodiment of the present disclosure;

FIG. 9 is a schematic diagram showing connection between the main wooden support and a fixed rod provided by the embodiment of the present disclosure;

FIG. 10 is a schematic diagram showing connection between the external wooden support and the fixed rod provided by the embodiment of the present disclosure;

FIG. 11 is a schematic diagram of a turns-variable device provided by the embodiment of the present disclosure; and

FIG. 12 is a schematic diagram showing connection between the turns-variable device and the transient electromagnetic device provided by the embodiment of the present disclosure.

Reference numerals: 1, transmitting coil; 2, square; 3, square buckle; 4, main wooden support; 5, external wooden support; 6, wooden support buckle; 7, fixed element; 8, fixed rod; 9, fixed rod circular ring; 10, turns-variable device input port; 11, turns-variable device; 12, turns-variable device mode; 13, turns-variable device output port; 14, connecting wire; 15, power supply; and 16, current generator.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. Based on the embodiment in the present disclosure, all other embodiments obtained by the ordinary technical staff in the art under the premise of without contributing creative labor belong to the scope protected by the present disclosure.

In the description of the present disclosure, the terminology used herein for the purpose of describing particular examples is not intended to be limiting for further examples. Whenever a singular form such as “a”, “an” and “the” is used and using only a single element is neither explicitly or implicitly defined as being mandatory, further examples may also use plural elements to implement the same functionality.

The present disclosure aims to provide a transient electromagnetic device with variable coil shapes and turns, and a use method thereof. According to the device, the stability and convenience of the transmitting coil carrying frame and the exploration precision are promoted, and the labor cost is reduced.

To make the foregoing objectives, features and advantages of the present disclosure clearer and more comprehensible, the present disclosure is further described in detail below with reference to the accompanying drawings and specific embodiments.

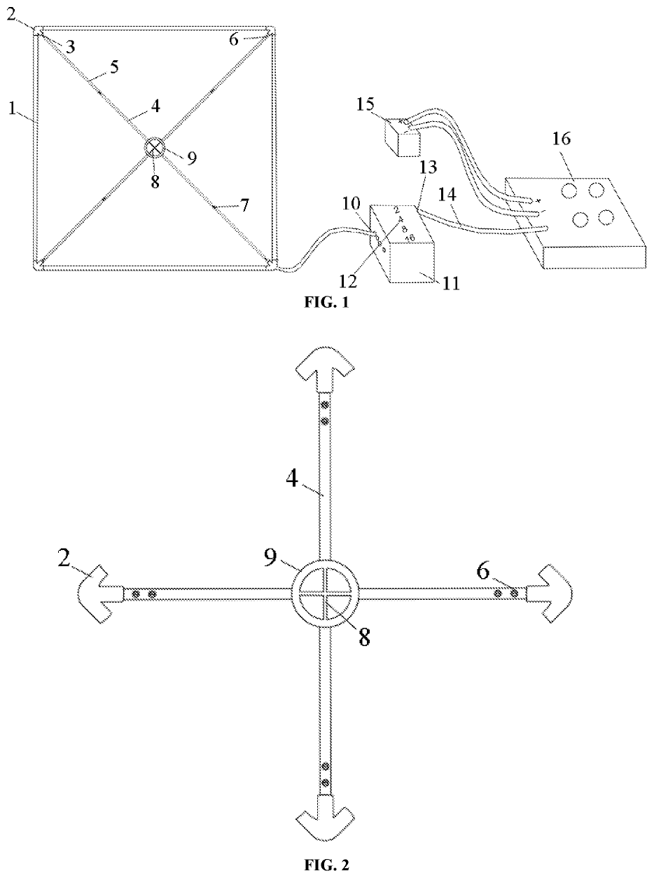

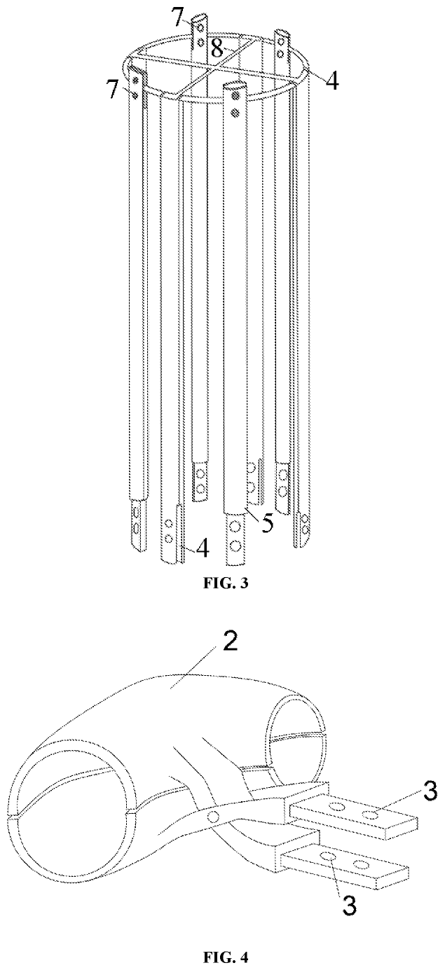

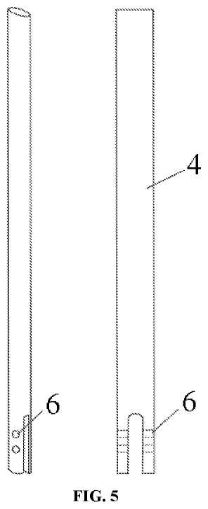

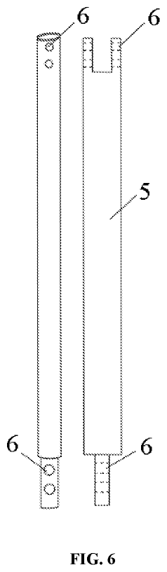

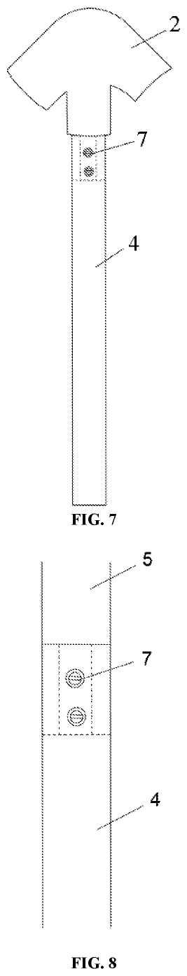

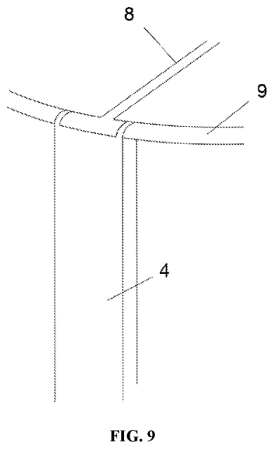

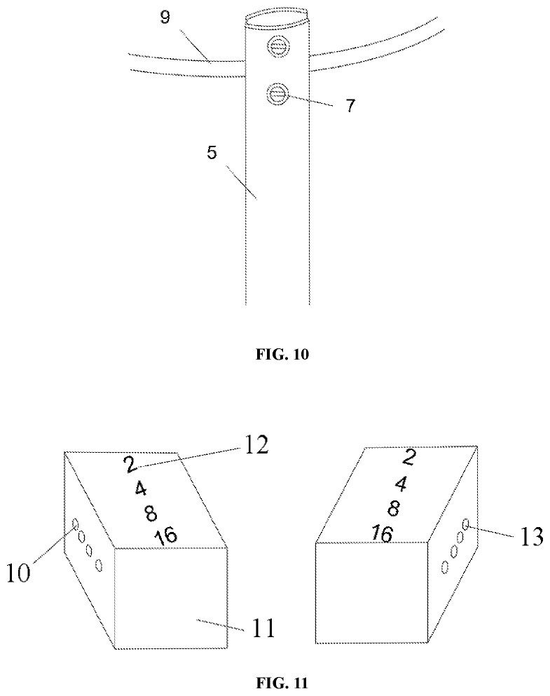

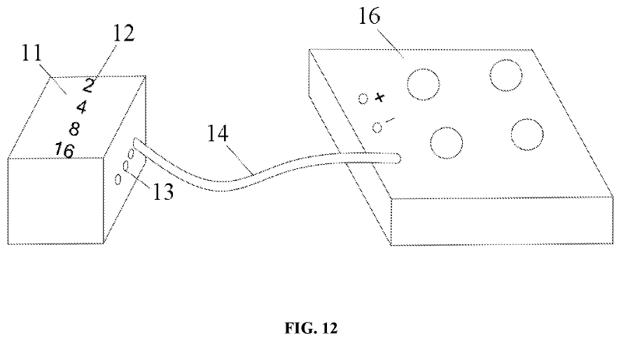

As shown in FIG. 1, the present disclosure provides a transient electromagnetic device with variable coil shapes and turns, it includes:

squares 2, a transmitting coil carrying frame, a transmitting coil 1, a turns-variable device 11, a current generator 16 and a power supply 15, where the a transmitting coil 1, the turns-variable device 11, the current generator 16 and the power supply 15 are sequentially connected through connecting wires 14.

The transmitting coil carrying frame is arranged inside the transmitting coil 1.

The transmitting coil carrying frame is configured as a carrier of the transmitting coil 1, and is configured for adjusting a side length of the transmitting coil 1 and a shape of the transmitting coil 1.

The squares 2 are configured for clamping and connecting the transmitting coil 1 and the transmitting coil 1 carrying frame to fix the transmitting coil 1 to the transmitting coil carrying frame; and the squares 2 should be tightly attached to the transmitting coil 1 and a wooden support.

According to the characteristic that the transmitting coil 1 is generally easy to fall off in the transmitting coil carrying frame, the detachable squares 2 are arranged in the transmitting coil carrying frame. The square 2 can be connected to a bottom of a main wooden support 4 and a top of an external wooden support 5. The squares 2 are mounted on the main wooden support 4 and the external wooden support 5 through buckles, and the buckles are fixed by a plurality of fixed elements 7. The fixed elements 7 include screws and plastic washers.

Before the squares 2 are connected to the main wooden support 4 or the external wooden support 5, the squares 2 are firstly pressed to be clamped onto the transmitting coil 1. A middle part of each square 2 is made to be concave. Clamping the square 2 to the transmitting coil 1 cannot influence current transmission of the transmitting coil 1.

A size of the square 2 in the transmitting coil carrying frame is matched with a diameter of the transmitting coil 1 and the wooden support.

A size of the transmitting coil carrying frame is matched with the transmitting coil 1.

The current generator 16 is used for generating transient current.

The turns-variable device 11 is used for changing the turns of the transmitting coil 1.

The transmitting coil 1 is configured for transmitting the transient current to a target area to be measured.

Further, the transmitting coil carrying frame includes:

a wooden support and a plurality of buckles.

The wooden support is attached to the transmitting coil 1, and the wooden support is connected with the transmitting coil 1 through the buckles; and the squares 2 are connected with the wooden support through the buckles. The transmitting coil carrying frame should be placed inside the transmitting coil 1. The wooden frame is tightly attached to the transmitting coil 1. The wooden frame and the transmitting coil 1 should form a right angle on the top. The transmitting coil carrying frame should be horizontally placed on the ground. The transmitting coil carrying frame should be selected to match with the transmitting coil 1.

Further, the wooden support includes:

four main wooden supports 4 and four external wooden supports 5.

Different lengths of the transmitting coil 1 are selected according to different exploration depths. The transmitting coil carrying frame is provided with the detachable external wooden supports 5. Referring to a length of the transmitting coil 1 in a common shadow transient instrument, the lengths of the main wooden supports 4 and the external wooden supports 5 are set to be 1 m. The main wooden support 4 and the external wooden support 5 in the transmitting coil carrying frame can be connected through the buckles. The buckles are divided into square buckles 3 and wooden support buckles.

Specifically, the transmitting coil 1 carrying frame further includes:

fixed elements 7, a fixed rod 8 and a fixed rod circular ring 9.

The main wooden supports 4 are connected to the external wooden supports 5 through the buckles; the screw and the plastic washer are arranged around the buckle and used for fixing the buckle; and the fixed rod 8 is connected to the fixed rod circular ring 9, and the fixed rod 8 is arranged at a connection point where the four main wooden supports 4 are connected. In the transmitting coil carrying frame, a connector between the main wooden support 4 and the fixed rod 8 should be made from a material with good insulating non-magnetism performance. The fixed rod 8 should be made from a wooden material with good insulating non-magnetism performance. In the transmitting coil carrying frame, the external wooden support 5 is connected with the fixed rod 8 through the buckle, and the buckle should be connected with the screw with good insulating non-magnetism performance.

The top of the main wooden support 4 is connected with the fixed rod circular ring 9 through a rotatable tenon-and-mortise structure, and the rotatable angle can be at most 90°. In the connecting process of the main wooden support 4 and the external wooden support 5, the buckle is fixed through the screw and the plastic washer.

In the transmitting coil carrying frame, the main wooden support 4 should be connected with the external wooden support 5 through the buckle, and the buckle is fixed through the screw and the plastic washer. The main wooden support 4 and the external wooden support 5 should be combined into a cylindrical support through rotation, and the cylindrical support is convenient to carry and transport in the field. The main wooden support 4 and the external wooden support 5 can be adjusted into a square structure with variable sizes according to requirements, such as 1*1, 2*2 and the like.

The transmitting coil carrying frame can be adjusted to be in a cylindrical shape through simple deformation when not used. The transmitting coil carrying frame is convenient to carry. The fixed rod 8 is arranged on the top of the transmitting coil carrying frame. When the transmitting coil carrying frame is adjusted to be in a cylindrical shape, the top of the main wooden support 4 and the top of the external wooden support 5 are connected to the circular ring outside the fixed rod 8.

In the using process of the transmitting coil carrying frame, the top of the main wooden support 4 can be unfolded to be horizontal through simple rotation. When the main wooden support 4 needs to be connected with the external wooden support 5, the screw and the plastic washer on the top of the external wooden support 5 are taken down, and the top of the external wooden support 5 is connected to the bottom of the main wooden support 4.

Further, the turns-variable device 11 has four modes: two ramps, four ramps, eight ramps and sixteen ramps. A shell of the turns-variable device 11 is made from a material with good insulating non-magnetism performance. Each ramp is provided with an input connector and an output connector. The input connector is connected to the current generator 16 through the connecting wire 14, and the output connector is connected to the transmitting coil 1 through a connector of the transmitting coil 1. A model of the connecting wire 14 in the turns-variable device 11 is matched with the turns-variable device 11 and the current generator 16. When a specific mode is selected, the transmitting coil 1 needs to be connected to an input port of the specific mode, and one end of the connecting wire 14 is connected to an output port of the specific mode. The turns-variable device 11 includes input ports 10 of the turns-variable device 11, modes 12 of the turns-variable device 11 and output ports 13 of the turns-variable device 11.

Further, the square 2 is made from an insulating non-magnetism material.

A use method of the transient electromagnetic device, includes the following steps:
determining a size of the transmitting coil 1 and the mode of the turns-variable device 11 according to an exploration depth;
mounting the transmitting coil carrying frame;
horizontally placing the transmitting coil carrying frame on the ground;
switching on the power supply;
debugging the transient electromagnetic device;
measuring the target area by using the transmitting coil 1; and
changing the shape of the transmitting coil carrying frame, and moving the transmitting coil carrying frame to a next target area.

Further, the step of changing the shape of the transmitting coil carrying frame and moving the transmitting coil carrying frame to the next target area includes the following step:

adjusting the shapes of the transmitting coil 1 and the transmitting coil carrying frame by changing the arrangement rule of the main wooden supports 4 and the external wooden supports 5.

Further, the shape of the transmitting coil carrying frame includes a cylindrical shape and a square shape.

The embodiment discloses a specific use method of the transient electromagnetic device, including the following steps.

a, Determining the size of the transmitting coil 1 and the number of turns according to the exploration depth, simply leveling an observation area, and clearing away possible electromagnetic interference objects in the area.

b, Adjusting the transmitting coil carrying frame. The transmitting coil carrying frame is horizontally placed on the ground, the top of the main wooden support 4 and the top of the external wooden support 5 are rotated so that the main wooden support 4 can be horizontally unfolded and placed on the ground. When the external wooden support 5 needs to be connected, the screw and the plastic washer on the top of the external wooden support 5 are taken down so that the external wooden support 5 is separated from the fixed rod circular ring 9. The bottom of the main wooden support 4 is connected with the top of the external wooden support 5 through the screw and the plastic washer.

c, Connecting the transmitting coil 1 and the transmitting coil carrying frame. The shape of the transmitting coil 1 is approximately arranged. The squares 2 in four directions are connected to the four main wooden supports 4 or the four external wooden supports 5. The square 2 is clamped on the transmitting coil 1 by pressing two ends of the square 2. The square 2 is connected to the bottom of the main wooden support 4 or the top of the external wooden support 5 through the screw and the plastic washer. The transmitting coil carrying frame is horizontally placed above the observation area.

d, Connecting the turns-variable device 11. The number of turns is determined according to the exploration depth and the precision requirement. One end of the transmitting coil 1 is connected to the input port 10 of the turns-variable device 11. One end of the connecting wire 14 is connected to the output port 13 of the turns-variable device 11, and the other end of the connecting wire 14 is connected to the current generator 16.

e, Connecting the working power supply 15. According to the working voltage of the current generator 16, the proper working power supply 15 is selected. For example, a 12V power supply is selectively used for the current generator 16. One end of the positive connecting wire 14 is connected to the power supply positive connector of the current generator 16, and the other end of the positive connecting wire 14 is connected to the positive connector of the working power supply 15. One end of the negative connecting wire 14 is connected to the power supply negative connector of the current generator 16, and the other end of the negative connecting wire 14 is connected to the negative connector of the working power supply 15.

f, Correcting the observation area. The size of the transmitting coil 1 and the number of turns are determined according to the exploration depth for exploration, and area images after exploration are analyzed so as to determine whether the size of the transmitting coil 1 selected and the number of turns selected are appropriate, and perform data recording.

g, Moving the transmitting coil carrying frame. After the correction of the observation area is completed, the observation area is formally measured. After the observation of the observation point by the transient electromagnetic device is completed, the transmitting coil carrying frame is moved along the direction of the measuring line. The transmitting coil carrying frame is placed on the next observation point. The steps are repeated until the observation of all observation points in the observation area is completed.

h, Dismounting and transporting the device. After the observation of all the observation points in the observation area is completed, the screws and the plastic washers at the joints of the squares 2, the main wooden supports 4 and the external wooden supports 5 are taken down by using a screw driver. The main wooden support 4 and the external wooden support 5 are rotated so that the transmitting coil carrying frame is adjusted to be in a cylindrical shape. The top of the external wooden support 5 is fixed by using the screw driver. The transmitting coil 1 is arranged, the connecting wire 14 between the transmitting coil 1 and the turns-variable device 11 are taken away, and the connecting wires 14 between the working power supply 15 and the transient electromagnetic device as well as the turns-variable device 11 and the transient electromagnetic device are taken away.

The present disclosure has the following beneficial effects.

The transmitting coil carrying frame can be applicable for larger transmitting coils 1 through the external wooden supports 5. The bottom of the main wooden support 4 and the top of the external wooden support 5 can be connected to the square 2. The square 2 can be clamped on the transmitting coil 1, so that the wooden supports are prevented from possibly falling off from the transmitting coil 1.

A traditional transmitting coil carrying frame is formed by two wooden supports. Three to four persons need to be participated in the implementation process. The traditional transmitting coil carrying frame is not easy to mount, and has a fixed length. After the present disclosure is improved, the whole exploration work can be completed only by two persons. And when the transmitting coil carrying frame is not used, it can be folded into the cylindrical shape, which is convenient to carry and transport in the field so that a great number of human and material resources are saved.

When device is moved among the observation points, an operator can directly carry the fixed rod 8 of the transmitting coil carrying frame to move, thereby reducing the physical consumption intensity of the operator, greatly improving the work efficiency, and reducing the working time. The device is good in effect and simple in operation. Operating points can be quickly grasped without complex skill training. The device is simple in construction and low in manufacturing cost, and is applicable for being used repeatedly and not easy to damage, thereby saving funds.

All embodiments in this specification are described in a progressive manner. Each embodiment focuses on differences from other embodiments. For the part that is the same or similar between different embodiments, reference may be made between the embodiments. The method disclosed in the embodiment corresponds to the device disclosed in the embodiment, and therefore the description is relatively brief. Related information refers to descriptions of the related parts in the device.

Several examples are used for illustration of the principles and implementation methods of the present disclosure. The description of the embodiments is used to help illustrate the method and the core principles of the present disclosure; and furthermore, those skilled in the art can make various modifications in terms of specific embodiments and scope of application in accordance with the teachings of the present disclosure. In conclusion, the content of this specification shall not be construed as a limitation to the present disclosure.

What is claimed is:

1. A transient electromagnetic device with variable coil shapes and turns, comprising:
a plurality of squares, a transmitting coil carrying frame, a transmitting coil, a turns-variable device, a current generator and a power supply, wherein the transmitting coil, the turns-variable device, the current generator and the power supply are sequentially connected;
wherein:
the transmitting coil carrying frame is arranged inside the transmitting coil;
the transmitting coil carrying frame is configured as a carrier for the transmitting coil, and is configured for adjusting a side length of the transmitting coil and a shape of the transmitting coil;
the plurality of squares are configured for clamping and connecting the transmitting coil and the transmitting coil carrying frame to fix the transmitting coil to the transmitting coil carrying frame;
the current generator is configured for generating transient current;
the turns-variable device is configured for changing the turns of the transmitting coil; and
the transmitting coil is configured for transmitting the transient current to a target area for measurement.

2. The transient electromagnetic device according to claim 1, wherein the transmitting coil carrying frame comprises:
a wooden support and a plurality of buckles;
the wooden support attached to the transmitting coil, wherein the wooden support is connected with the transmitting coil through the buckles; and the plurality of squares are connected with the wooden support through the buckles.

3. The transient electromagnetic device according to claim 2, wherein the wooden support comprises:
four main wooden supports and four external wooden supports.

4. The transient electromagnetic device according to claim 3, wherein the transmitting coil carrying frame further comprises:
fixed elements, a fixed rod and a fixed rod circular ring;
wherein the main wooden supports are connected to the external wooden supports through the buckles;
screws and plastic washers are arranged around the buckles to fix the buckles; and
the fixed rod is connected to the fixed rod circular ring, the fixed rod arranged at a connecting point where the four main wooden supports are connected.

5. The transient electromagnetic device according to claim 1, wherein the turns-variable device comprises four modes: two ramps, four ramps, eight ramps and sixteen ramps.

6. The transient electromagnetic device according to claim 1, wherein the plurality of squares are made from an insulating non-magnetism material.

7. In a transient electromagnetic device with variable coil shapes and turns, the transient electromagnetic device comprising a plurality of squares, a transmitting coil carrying frame, a transmitting coil, a turns-variable device, a current generator and a power supply, wherein the transmitting coil, the turns-variable device, the current generator and the power supply are sequentially connected; the transmitting coil carrying frame being arranged inside the transmitting coil; the transmitting coil carrying frame configured as a carrier for the transmitting coil, and configured for adjusting a side length of the transmitting coil and a shape of the transmitting coil; the plurality of squares configured for clamping and connecting the transmitting coil and the transmitting coil carrying frame to fix the transmitting coil to the transmitting coil carrying frame; the current generator configured for generating transient current; the turns-variable device configured for changing the turns of the transmitting coil; and the transmitting coil configured for transmitting the transient current to a target area for measurement, a method comprising:
determining a size of the transmitting coil and a mode of the turns-variable device according to an exploration depth;
mounting the transmitting coil carrying frame;
horizontally placing the transmitting coil carrying frame on ground;
switching on the power supply;
debugging the transient electromagnetic device;
measuring a target area by using the transmitting coil; and
changing a shape of the transmitting coil carrying frame, and moving the transmitting coil carrying frame to a next target area.

8. The method according to claim 7, wherein changing the shape of the transmitting coil carrying frame comprises:
adjusting a shape of the transmitting coil and the shape of the transmitting coil carrying frame by changing arrangement rules of the main wooden supports and the external wooden supports.

9. The method according to claim 7, wherein the shape of the transmitting coil carrying frame comprises a cylindrical shape and a square shape.

10. The method according to claim 7, wherein the transmitting coil carrying frame comprises:
a wooden support and a plurality of buckles; the wooden support attached to the transmitting coil, and the wooden support connected with the transmitting coil through the buckles; and wherein the plurality of squares are connected with the wooden support through the buckles.

11. The method according to claim 10, wherein the wooden support comprises: four main wooden supports and four external wooden supports.

12. The method according to claim 11, wherein the transmitting coil carrying frame further comprises:
fixed elements, a fixed rod and a fixed rod circular ring;
wherein the main wooden supports are connected to the external wooden supports through the buckles; screws and plastic washers are arranged around the buckles to fix the buckles; and the fixed rod is connected to the fixed rod circular ring, and wherein the fixed rod is arranged at a connecting point where the four main wooden supports are connected.

13. The method according to claim 7, wherein the turns-variable device comprises four modes: two ramps, four ramps, eight ramps and sixteen ramps.

14. The method according to claim 7, wherein the plurality of squares are made from an insulating non-magnetism material.
